(19) United States
(12) Patent Application Publication
(10) Pub. No.: US 2013/0068328 A1
(43) Pub. Date: Mar. 21, 2013

(54) Gerotor Pump Assembly and Engine Fluid Delivery System Using a Gerotor Pump Assembly

(71) Applicants: Shailendra Kashinath Kardile, Peoria, IL (US); Joe Ralph Baird, Metamora, IL (US); Yuanhong Guan, Peoria, IL (US)

(72) Inventors: Shailendra Kashinath Kardile, Peoria, IL (US); Joe Ralph Baird, Metamora, IL (US); Yuanhong Guan, Peoria, IL (US)

(73) Assignee: CATERPILLAR, INC., Peoria, IL (US)

(21) Appl. No.: 13/234,737

(22) Filed: Sep. 16, 2011

(51) Int. Cl. F16D 31/02; F01C 1/10

(52) U.S. Cl. 137/565.37; 418/61.3

(57) ABSTRACT

A gerotor pump assembly includes a gerotor pump and a relief valve assembly. The relief valve assembly is operably coupled to the pump housing and includes a relief valve inlet in fluid communication with a compression portion of the pump housing, a relief valve outlet defining a first seating surface, and a valve element sized to extend over the relief valve outlet and defining a second seating surface configured for engagement with the first seating surface. The valve element is deformable between a normal position, in which the second seating surface engages the first seating surface, and a deflected position, in which the second seating surface is spaced from the first seating surface to relieve fluid pressure.

### TECHNICAL FIELD

The present disclosure generally relates to gerotor pump assemblies, and more particularly relief valves used with such pump assemblies.

### BACKGROUND

Gerotor type hydraulic pumps typically include an internally toothed outer gerotor and an externally toothed inner gerotor disposed in a pump housing. The teeth on the respective gerotors cooperate to define a plurality of variable volume chambers. When the gerotors are rotated, a variable volume chamber will initially increase in volume to create a low pressure or suction area, and subsequently decrease in volume to create a high pressure or compression area. An inlet port communicates with the low pressure area so that fluid in the inlet port is drawn into the variable volume chamber. Upon further rotation, whereupon the variable volume chamber decreases in volume, the fluid is discharged through an outlet port at an elevated pressure. When the gerotors rotate at high speeds, the fluid pressure may increase to undesirable levels. Accordingly, a relief valve may be used to reduce fluid overpressure.

Conventional gerotor relief valves are not sufficiently responsive to avoid complications due to fluid overpressure. In an engine fluid delivery system such as an engine oil pump system, for example, repeated fluid overpressure may impact other components in the system. Conventional relief valves may use a spring-loaded plunger that shuttles from a closed position to an open position when the oil pressure exceeds the spring force. As the plunger travels to the open position, however, oil pressure may continue to build, thereby generating high pressure spikes. During a pressure spike, high pressure oil is communicated from the pump outlet that may deflect downstream components, causing excessive noise.

### SUMMARY OF THE DISCLOSURE

According to certain aspects of this disclosure, a gerotor pump assembly includes a pump housing defining a suction portion and a compression portion, an outer gerotor rotatably disposed within the pump housing, and an inner gerotor rotatably disposed within the pump housing and operably engaging the outer gerotor to define a plurality of variable volume chambers, wherein during rotation of the inner and outer gerotors the variable volume chambers located in the suction portion of the pump housing increase in volume and the variable volume chambers located in the compression portion of the pump housing decrease in volume. A relief valve assembly includes a relief valve inlet in fluid communication with the compression portion of the pump housing, a relief valve outlet defining a first seating surface, and a valve element sized to extend over the relief valve outlet and defining a second seating surface configured for engagement with the first seating surface. The valve element is deformable between a normal position, in which the second seating surface engages the first seating surface, and a deflected position, in which the second seating surface is spaced from the first seating surface.

In another aspect of the disclosure that may be combined with any of these aspects, an engine fluid delivery system for a machine includes a sump for holding an engine fluid. A gerotor pump includes a pump housing defining an internal chamber having a suction portion and a compression portion, the pump housing including a pump inlet in fluid communication with the suction portion and a pump outlet in fluid communication with the compression portion, an outer gerotor rotatably disposed within the pump housing, and an inner gerotor rotatably disposed within the pump housing and operably engaging the outer gerotor to define a plurality of variable volume chambers, wherein during rotation of the inner and outer gerotors the variable volume chambers located in the suction portion of the pump housing increase in volume and the variable volume chambers located in the compression portion of the pump housing decrease in volume. A suction tube has an outlet end coupled to the pump inlet and an inlet end disposed in the sump. A relief valve assembly includes a relief valve inlet in fluid communication with the compression portion of the pump housing, a relief valve outlet defining a first seating surface, and a valve element sized to extend over the relief valve outlet and defining a second seating surface configured for engagement with the first seating surface. The valve element is deformable between a normal position, in which the second seating surface engages the first seating surface, and a deflected position, in which the second seating surface is spaced from the first seating surface.

In another aspect of the disclosure that may be combined with any of these aspects, an engine fluid delivery system is provided for a machine that includes a sump for holding an engine fluid. A gerotor pump includes a pump housing defining an internal chamber having a suction portion and a compression portion, the pump housing including a pump inlet in fluid communication with the suction portion and a pump outlet in fluid communication with the compression portion, an outer gerotor rotatably disposed within the pump housing, and an inner gerotor rotatably disposed within the pump housing and operably engaging the outer gerotor to define a plurality of variable volume chambers, wherein during rotation of the inner and outer gerotors the variable volume chambers located in the suction portion of the pump housing increase in volume and the variable volume chambers located in the compression portion of the pump housing decrease in volume. A suction tube has an outlet end coupled to the pump inlet and an inlet end disposed in the sump. A relief valve assembly includes a relief valve inlet in fluid communication with the compression portion of the pump housing, a relief valve outlet defining a first seating surface, and a valve element sized to extend over the relief valve outlet and defining a second seating surface configured for engagement with the first seating surface. The valve element is deformable between a normal position, in which the second seating surface engages the first seating surface, and a deflected position, in which the second seating surface is spaced from the first seating surface. The valve element is formed of a set of first Belleville washers having apices oriented away from the first seating surface when in the normal position, wherein the set of first Belleville washers automatically actuates from the normal position to the deflected position in response to a fluid pressure at the relief valve outlet exceeding a fluid pressure limit. The relief valve assembly further includes a resilient mechanism operably coupled to the valve element, the resilient mechanism being movable between an expanded position, in which the resilient mechanism biases the valve element toward the first seating surface, and a contracted position, in which the resilient mechanism contracts to permit the valve element to slide away from the second seating surface. The resilient mechanism is formed as a second set of Belleville washers having apices oriented toward the first seating surface when in the expanded position.

In another aspect of the disclosure that may be combined with any of these aspects, the valve element is formed as a first Belleville washer having an apex oriented away from the first seating surface when in the normal position.

In another aspect of the disclosure that may be combined with any of these aspects, an adapter is coupled to the pump housing and the relief valve assembly is operably coupled to the adapter.

In another aspect of the disclosure that may be combined with any of these aspects, a pump outlet is in fluid communication with the compression portion of the pump housing, and an outlet pipe is coupled to the pump outlet.

In another aspect of the disclosure that may be combined with any of these aspects, the outlet pipe includes an elbow section defining an outlet flow path and a bypass section defining a bypass flow path fluidly communicating with the outlet flow path, and in which the relief valve assembly is coupled to the outlet pipe.

In another aspect of the disclosure that may be combined with any of these aspects, the pump housing further defines a relief chamber, and the relief valve assembly is coupled to the relief chamber.

In another aspect of the disclosure that may be combined with any of these aspects, the relief valve outlet fluidly communicates with the suction portion of the pump housing.

In another aspect of the disclosure that may be combined with any of these aspects, the relief valve assembly further includes a resilient mechanism operably coupled to the valve element, the resilient mechanism being movable between an expanded position, in which the resilient mechanism biases the valve element toward the first seating surface, and a contracted position, in which the resilient mechanism contracts to permit the valve element to slide farther away from the first seating surface.

In another aspect of the disclosure that may be combined with any of these aspects, the valve element comprises a first set of Belleville washers having apices oriented away from the first seating surface when in the normal position, and in which the resilient mechanism comprises a second set of Belleville washers having apices oriented toward the first seating surface when in the expanded position.

In another aspect of the disclosure that may be combined with any of these aspects, the valve element automatically actuates from the normal position to the deflected position in response to a fluid pressure at the relief valve outlet exceeding a fluid pressure limit.

### BRIEF DESCRIPTION OF THE DRAWINGS

FIG. 1 is a schematic perspective view of an engine oil delivery system having a gerotor pump assembly

FIG. 2 is a schematic side elevational view, in cross-section, of a gerotor pump having a relief valve assembly disposed on an adapter coupled to a pump housing, constructed according to a first embodiment of this disclosure.

FIG. 3 is an exploded perspective view of the gerotor pump and relief valve assembly of FIG. 2.

FIG. 4 is a schematic side elevational view, in cross-section, of an alternative embodiment of a relief valve assembly that can be coupled to an outlet of a gerotor pump.

FIG. 5 is a schematic side elevational view, in cross-section, of yet another alternative embodiment of a relief valve assembly disposed within a housing of a gerotor pump.

### DETAILED DESCRIPTION

Multiple embodiments of a gerotor pump assembly having a relief valve are disclosed for use in an engine fluid delivery system. The engine fluid delivery system is described herein as an engine oil pump system, however it will be appreciated that the gerotor pump assembly may be used to deliver fuel or other types of fluids to the engine. Additionally, the engine fluid delivery system may be used on any type of machine, stationary or mobile, that requires a circulating fluid. The relief valve embodiments disclosed herein provide improved responsiveness to high fluid pressure, thereby reducing the number of fluid pressure spikes and related engine noise level.

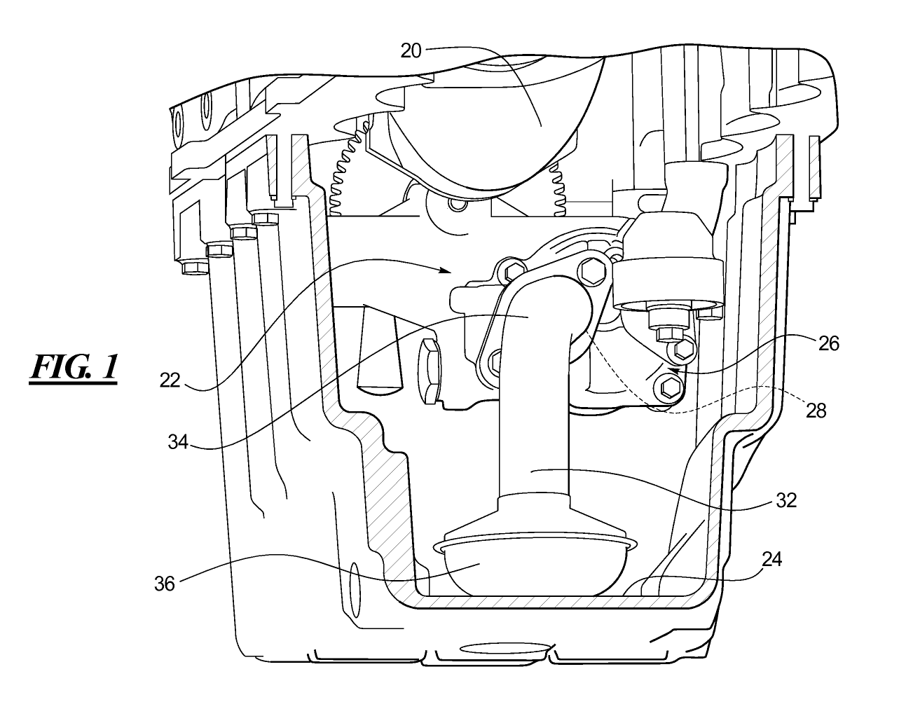

Turning to the illustrated embodiments, FIG. 1 shows a portion of an engine 20 for a machine. An oil delivery system 22 is operably coupled to the engine 20 and configured to retrieve oil from a sump 24 and deliver it to the engine 20 at an elevated pressure. Accordingly, the oil delivery system 22 includes a gerotor pump 26 having a pump inlet 28 and a pump outlet 30. A suction tube 32 has an outlet end 34 coupled to the pump inlet 28 and an inlet end 36 disposed in the sump 24. The gerotor pump 26 is operable to draw oil from the sump 24 through the suction tube 32 and discharge it through the pump outlet 30 at an elevated pressure.

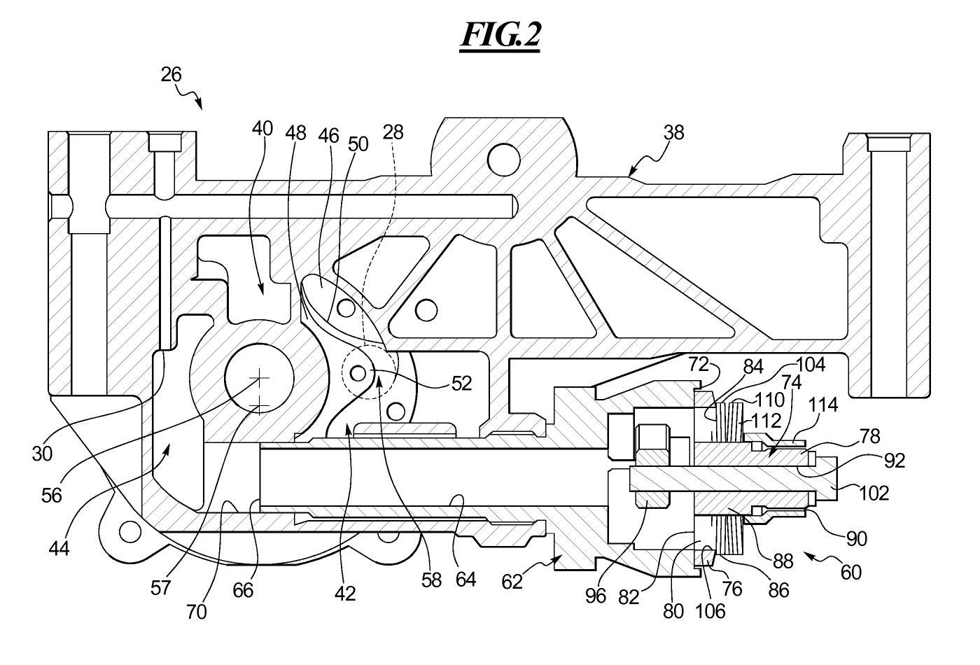

Referring to FIG. 2, the gerotor pump 26 includes a pump housing 38 defining an internal chamber 40. As better understood below, the internal chamber 40 has a suction portion 42 and a compression portion 44. The pump housing 38 defines the pump inlet 28 (shown schematically in FIG. 2), which fluidly communicates with the suction portion 42, and the pump outlet 30, which fluidly communicates with the compression portion 44.

The gerotor pump 26 further includes an outer gerotor 46 and an inner gerotor 48 for generating a pressure differential within the pump housing 38. The outer gerotor 46 has inwardly extending teeth 50, while the inner gerotor 48 has outwardly extending teeth 52 that operably engage the inwardly extending teeth 50 of the outer gerotor 46. The outer gerotor 46 is supported for rotation about a first axis 54, while inner gerotor 48 is supported for rotation about a second axis 56 that is spaced from the first axis 54 to effect a gear eccentricity that permits proper operation of the gerotor pump 26. In addition, the inner gerotor 48 may have one less tooth than the outer gerotor 46 to reduce excessive wear on any one portion of the gerotors 46, 48. A plurality of variable volume chambers 58 are defined between engaged pairs of inwardly extending teeth 50 and outwardly extending teeth 52. When the outer gerotor 46 and inner gerotor 48 are rotated, a variable volume chamber 58 will increase in volume as it travels through the suction portion 42 of the internal chamber 40, thereby to produce a relatively low pressure that draws fluid into the variable volume chamber 58. Subsequently, as the gerotors 46, 48 continue to rotate, the variable volume chamber 58 will decrease in volume as it travels through the compression portion 44 of the internal chamber 40, thereby to produce a relatively high pressure that discharges fluid from the variable volume chamber 58.

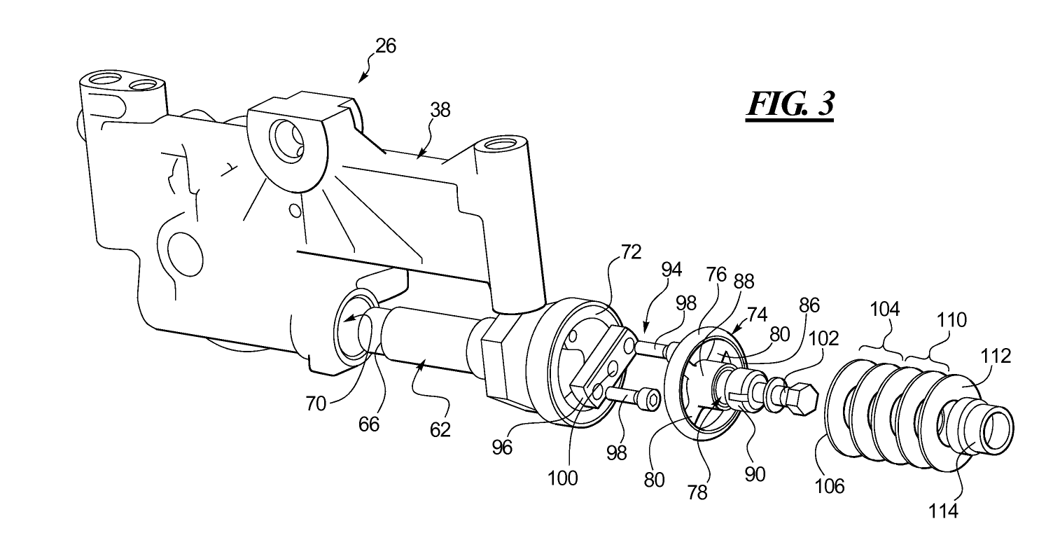

A relief valve assembly 60 is operably coupled to the gerotor pump 26 to allow a bypass flow of fluid when the fluid pressure exiting the pump outlet 30 exceeds a pressure limit In a first embodiment illustrated in FIGS. 2 and 3, an adapter 62 is coupled to the pump housing 38 and defines an adapter passage 64. The adapter 62 has an inlet end 66 fluidly communicating with a relief chamber 70 formed in the pump housing 38. The relief chamber 70, in turn, fluidly communicates with the compression portion 44 of the internal chamber 40, so that outlet fluid pressure is communicated to the adapter passage 64. The relief valve assembly 60 is coupled to an outlet end 72 of the adapter 62.

The relief valve assembly 60 includes a valve body 74 having an outer ring 76 coupled to a boss 78 by a plurality of webs 80. The outer ring 76 engages the adapter outlet end 72 and defines a relief valve inlet 82 and a relief valve outlet 84. The relief valve outlet 84 defines a first seating surface 86. The boss 78 extends away from the relief valve outlet 84 and includes a relatively smooth guide portion 88 and a threaded portion 90. A central aperture 92 extends through the boss 78.

The valve body 74 is coupled to the adapter 62 by a mounting assembly 94 that includes a flange 96 fixed to the adapter 62 using fasteners 98. The flange 96 defines a threaded aperture 100 sized to threadably receive a threaded end of fastener 102, which extends through the central aperture 92. The fastener 102 may be threaded into the threaded aperture 100 to secure the outer ring 76 of the valve body 74 against the adapter outlet end 72.

A valve element 104 is disposed on the boss 78 of the valve body 74 to control fluid flow through the relief valve outlet 84. The valve element 104 defines a second seating surface 106 configured to sealingly engage the first seating surface 86 in a normal position. The valve element 104 is deformable from the normal position illustrated in FIG. 2 to a deflected position, in which the second seating surface 106 is spaced from the first seating surface 86, thereby to permit fluid to flow through the relief valve outlet 84. The valve element 104 is configured, such as by size, shape, and material selection, to automatically actuate from the normal position to the deflected position in response to a fluid pressure at the relief valve outlet 84 exceeding a selected fluid pressure limit.

In the illustrated embodiment, the valve element 104 is formed by a first set of Belleville washers having apices normally oriented away from the first seating surface 86. In the illustrated embodiment, a pair of Belleville washers are used, however it will be appreciated that a single washer or more than two washers may be used. When the fluid pressure exceeds the fluid pressure limit, the Belleville washers are deflected to be substantially planar, thereby providing a space between the first and second seating surfaces 86, 106 through which fluid may be discharged to collect in the sump 24.

The relief valve assembly 60 may further include a resilient mechanism 110 that contracts to increase the space between the first and second seating surfaces 86, 106 when the valve element 104 actuates to the deflected position. The resilient mechanism is disposed on the boss 78 of the valve body 74 and engages a back side of the valve element 104. The resilient mechanism 110 has an expanded position in which it exerts a spring force to bias the valve element 104 toward the first seating surface 86. When the fluid pressure exerted through the valve element 104 and against the resilient mechanism 110 exceeds the spring force, the resilient mechanism 110 will automatically actuate to a contracted position, thereby permitting the valve element to translate along the guide portion 88 of the boss 78. Consequently, with the resilient mechanism 110 retracted, the second seating surface 106 of the valve element 104 is permitted to travel farther away from the first seating surface 86, thereby permitting a greater volume of fluid to pass through the relief valve outlet 84.

In the illustrated embodiment, the resilient mechanism 110 is formed by a second set of Belleville washers having apices oriented toward the first seating surface 86 when in the expanded position. While a pair of Belleville washers is shown in the drawing, it will be appreciated that a single washer or more than two washers may be used. A backup washer 112 is provided against which the resilient mechanism 110 may be pressed when moving to the contracted position. In operation, both the first and second sets of Belleville washers may deflect to be substantially planar, thereby opening the relief valve outlet 84. A retainer 114 may be threadably attached to the threaded portion 90 of the boss 78 to hold the valve element 104 and resilient mechanism 110 in place on the boss 78. Alternatively, the retainer 114 may be press fit or staked in place onto the boss 78.

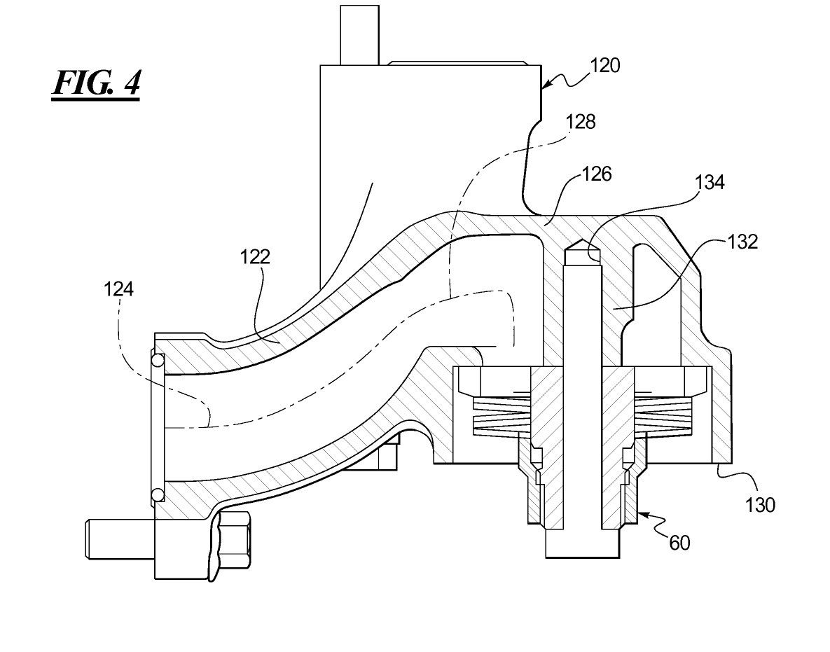

FIG. 4 illustrates the relief valve assembly 60 installed in an alternative location. Instead of using an adapter coupled to the pump housing, the relief valve assembly 60 is coupled to an outlet pipe 120 that fluidly communicates with the pump outlet 30. It will further be appreciated that the relief valve assembly 60 may be located at any point downstream of the pump outlet 30 and prior to the first engine component in the fluid circuit. The outlet pipe 120 includes an elbow section 122 defining an outlet flow path 124 and a bypass section 126 defining a bypass flow path 128 that fluidly communicates with the outlet flow path 124. The bypass section 126 defines an outlet end 130, and a stub shaft 132 is formed in the bypass section 126. The stub shaft 132 defines a threaded aperture 134 for receiving the fastener 102, thereby obviating the need for a mounting assembly. Instead, the relief valve assembly 60 may be secured directly to the stub shaft 132 of the outlet pipe 120. Otherwise, the relief valve assembly 60 is identical to that shown in FIGS. 1 and 2.

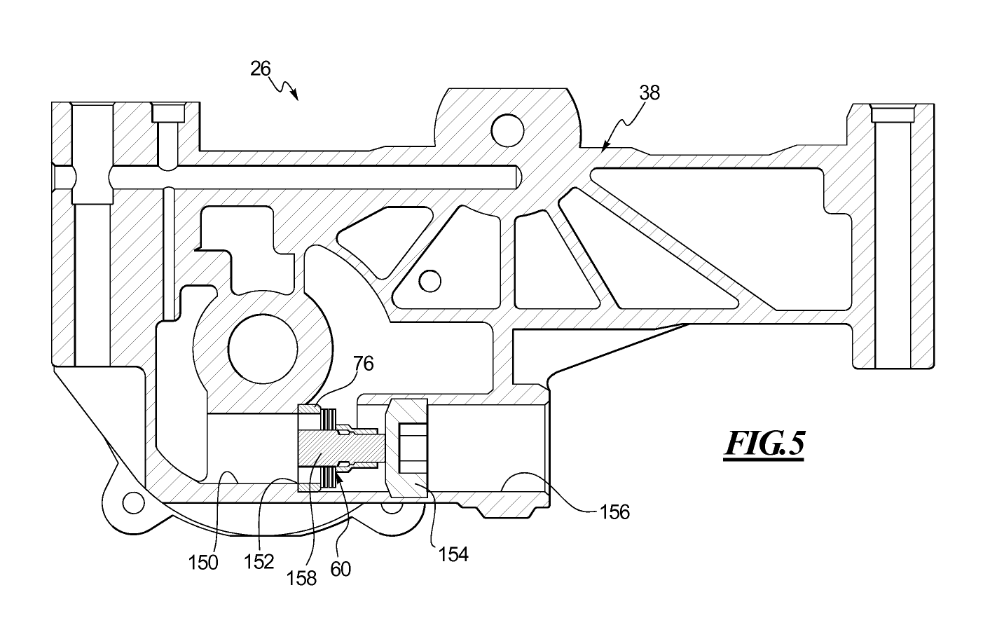

A further alternative location for the relief valve assembly 60 is illustrated in FIG. 5. In this embodiment, the relief valve assembly 60 is mounted entirely within the pump housing 38. The pump housing 38 defines a relief chamber 150 fluidly communicating with the compression portion 44 of the internal chamber 40. The relief valve assembly 60 is coupled to an outlet end 152 of the relief chamber 150. A plug 154 is provided to seal off a relief chamber extension 156, so that the relief valve assembly 60 is completely contained within the pump housing 38. A modified valve body 158 is used that does not have a central aperture. Instead, the outer ring 76 is fixed directly to the outlet end 152 of the relief chamber 150. Otherwise, the relief valve assembly 60 is substantially identical to the embodiments illustrated in FIGS. 2-4. With the location of the relief valve assembly 60 within the pump housing 38, however, the relief valve outlet 84 may communicate with the suction portion 42 of the internal chamber 40, thereby allowing fluid to be returned directly to the pump inlet instead of to the sump 24.

### INDUSTRIAL APPLICABILITY

The present disclosure is applicable to machines that include a gerotor pump assembly to deliver fluid to an engine. The gerotor pump assembly may provide oil, fuel, or other fluid needed by the engine. The engine may be provided on a mobile or stationary machine. The gerotor pump assembly includes a relief valve assembly 60 that automatically opens when the fluid pressure exceeds a selected pressure limit The relief valve assembly 60 uses minimal parts and has a valve element 104 that deflects, thereby to more quickly respond to excessive fluid pressure.

For example, conventional relief valve assemblies use a spring-loaded plunger that must shuttle from a closed position near a pump outlet port to an open position near a pump inlet port. The configuration of the plunger and the distance that it must travel reduces the responsiveness of the conventional relief valve. As a result, during operation of certain engines, the outlet fluid pressure may spike to 3,000 kPa or more. The valve element 104 of the relief valve assembly 60 disclosed herein, however, merely deflects to open the valve, thereby improving responsiveness. As a result, use of the relief valve assembly 60 in the same application substantially limits pressure spikes to approximately 1,300 kPa or less. Accordingly, the engine noise associated with higher pressure spikes is substantially eliminated. The relief valve assembly 60 further has fewer moving parts and therefore is more reliable than the conventional relief valves used with gerotor pumps.

It will be appreciated that the foregoing description provides examples of the disclosed assembly and technique. However, it is contemplated that other implementations of the disclosure may differ in detail from the foregoing examples. All references to the disclosure or examples thereof are intended to reference the particular example being discussed at that point and are not intended to imply any limitation as to the scope of the disclosure more generally. All language of distinction and disparagement with respect to certain features is intended to indicate a lack of preference for those features, but not to exclude such from the scope of the disclosure entirely unless otherwise indicated.

Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context.

Accordingly, this disclosure includes all modifications and equivalents of the subject matter recited in the claims appended hereto as permitted by applicable law. Moreover, any combination of the above-described elements in all possible variations thereof is encompassed by the disclosure unless otherwise indicated herein or otherwise clearly contradicted by context.

What is claimed is:

1. A gerotor pump assembly, comprising:
a pump housing defining a suction portion and a compression portion;
an outer gerotor rotatably disposed within the pump housing;
an inner gerotor rotatably disposed within the pump housing and operably engaging the outer gerotor to define a plurality of variable volume chambers, wherein during rotation of the inner and outer gerotors the variable volume chambers located in the suction portion of the pump housing increase in volume and the variable volume chambers located in the compression portion of the pump housing decrease in volume; and
a relief valve assembly including:
a relief valve inlet in fluid communication with the compression portion of the pump housing;
a relief valve outlet defining a first seating surface; and
a valve element sized to extend over the relief valve outlet and defining a second seating surface configured for engagement with the first seating surface, the valve element being deformable between a normal position, in which the second seating surface engages the first seating surface, and a deflected position, in which the second seating surface is spaced from the first seating surface.

2. The gerotor pump assembly of claim 1, in which the valve element comprises a first Belleville washer having an apex oriented away from the first seating surface when in the normal position.

3. The gerotor pump assembly of claim 1, further including an adapter coupled to the pump housing, in which the relief valve assembly is operably coupled to the adapter.

4. The gerotor pump assembly of claim 1, further including a pump outlet in fluid communication with the compression portion of the pump housing, and an outlet pipe coupled to the pump outlet.

5. The gerotor pump assembly of claim 4, in which the outlet pipe includes an elbow section defining an outlet flow path and a bypass section defining a bypass flow path fluidly communicating with the outlet flow path, and in which the relief valve assembly is coupled to the outlet pipe.

6. The gerotor pump assembly of claim 1, in which the pump housing further defines a relief chamber, and in which the relief valve assembly is coupled to the relief chamber.

7. The gerotor pump assembly of claim 6, in which the relief valve outlet fluidly communicates with the suction portion of the pump housing.

8. The gerotor pump assembly of claim 1, in which the relief valve assembly further includes a resilient mechanism operably coupled to the valve element, the resilient mechanism being movable between an expanded position, in which the resilient mechanism biases the valve element toward the first seating surface, and a contracted position, in which the resilient mechanism contracts to permit the valve element to slide farther away from the first seating surface.

9. The gerotor pump assembly of claim 8, in which the valve element comprises a first set of Belleville washers having apices oriented away from the first seating surface when in the normal position, and in which the resilient mechanism comprises a second set of Belleville washers having apices oriented toward the first seating surface when in the expanded position.

10. The gerotor pump assembly of claim 1, in which the valve element automatically actuates from the normal position to the deflected position in response to a fluid pressure at the relief valve outlet exceeding a fluid pressure limit.

11. An engine fluid delivery system for a machine, comprising:
a sump for holding an engine fluid;
a gerotor pump including:
a pump housing defining an internal chamber having a suction portion and a compression portion, the pump housing including a pump inlet in fluid communication with the suction portion and a pump outlet in fluid communication with the compression portion;
an outer gerotor rotatably disposed within the pump housing; and
an inner gerotor rotatably disposed within the pump housing and operably engaging the outer gerotor to define a plurality of variable volume chambers, wherein during rotation of the inner and outer gerotors the variable volume chambers located in the suction portion of the pump housing increase in volume and the variable volume chambers located in the compression portion of the pump housing decrease in volume;
a suction tube having an outlet end coupled to the pump inlet and an inlet end fluidly coupled to the sump;
a relief valve assembly including:
a relief valve inlet in fluid communication with the compression portion of the pump housing;
a relief valve outlet defining a first seating surface; and
a valve element sized to extend over the relief valve outlet and defining a second seating surface configured for engagement with the first seating surface, the valve element being deformable between a normal position, in which the second seating surface engages the first seating surface, and a deflected position, in which the second seating surface is spaced from the first seating surface.

12. The engine fluid delivery system of claim 11, in which the valve element comprises a first Belleville washer having an apex oriented away from the first seating surface when in the normal position.

13. The engine fluid delivery system of claim 11, further including an adapter coupled to the pump housing, in which the relief valve assembly is operably coupled to the adapter.

14. The engine fluid delivery system of claim 11, in which the gerotor pump includes a pump outlet in fluid communication with the compression portion of the pump housing, and an outlet pipe coupled to the pump outlet.

15. The engine fluid delivery system of claim 14, in which the outlet pipe includes an elbow section defining an outlet flow path and a bypass section defining a bypass flow path fluidly communicating with the outlet flow path, and in which the relief valve assembly is coupled to the outlet pipe.

16. The engine fluid delivery system of claim 11, in which the pump housing further defines a relief chamber, and in which the relief valve assembly is coupled to the relief chamber.

17. The engine fluid delivery system of claim 16, in which the relief valve outlet fluidly communicates with the suction portion of the pump housing.

18. The engine fluid delivery system of claim 11, in which the relief valve assembly further includes a resilient mechanism operably coupled to the valve element, the resilient mechanism being movable between an expanded position, in which the resilient mechanism biases the valve element toward the first seating surface, and a contracted position, in which the resilient mechanism contracts to permit the valve element to slide farther away from the first seating surface.

19. The engine fluid delivery system of claim 18, in which the valve element comprises a first set of Belleville washers having apices oriented away from the first seating surface when in the normal position, and in which the resilient mechanism comprises a second set of Belleville washers having apices oriented toward the first seating surface when in the expanded position.

20. An engine fluid delivery system for a machine, comprising:
a sump for holding an engine fluid;
a gerotor pump including:
a pump housing defining an internal chamber having a suction portion and a compression portion, the pump housing including a pump inlet in fluid communication with the suction portion and a pump outlet in fluid communication with the compression portion;
an outer gerotor rotatably disposed within the pump housing; and
an inner gerotor rotatably disposed within the pump housing and operably engaging the outer gerotor to define a plurality of variable volume chambers, wherein during rotation of the inner and outer gerotors the variable volume chambers located in the suction portion of the pump housing increase in volume and the variable volume chambers located in the compression portion of the pump housing decrease in volume;
a suction tube having an outlet end coupled to the pump inlet and an inlet end fluidly coupled to the sump;
a relief valve assembly including:
a relief valve inlet in fluid communication with the compression portion of the pump housing;
a relief valve outlet defining a first seating surface;
a valve element sized to extend over the relief valve outlet and defining a second seating surface configured for engagement with the first seating surface, the valve element being deformable between a normal position, in which the second seating surface engages the first seating surface, and a deflected position, in which the second seating surface is spaced from the first seating surface, the valve element comprising a set of first Belleville washers having apices oriented away from the first seating surface when in the normal position, wherein the set of first Belleville washers automatically actuates from the normal position to the deflected position in response to a fluid pressure at the relief valve outlet exceeding a fluid pressure limit; and
a resilient mechanism operably coupled to the valve element, the resilient mechanism being movable between an expanded position, in which the resilient mechanism biases the valve element toward the first seating surface, and a contracted position, in which the resilient mechanism contracts to permit the valve element to slide away from the second seating surface, wherein the resilient mechanism comprises a second set of Belleville washers having apices oriented toward the first seating surface when in the expanded position.
